(19) United States
(12) Patent Application Publication
(10) Pub. No.: US 2025/0193319 A1
(43) Pub. Date: Jun. 12, 2025

(54) IMAGE READING APPARATUS, CONTROL METHOD THEREOF, AND STORAGE MEDIUM

(71) Applicant: CANON KABUSHIKI KAISHA, Tokyo (JP)

(72) Inventor: YUKI KAMIO, Kanagawa (JP)

(21) Appl. No.: 18/974,537

(22) Filed: Dec. 9, 2024

(30) Foreign Application Priority Data
Dec. 11, 2023 (JP) 2023-208815

(51) Int. Cl. H04N 1/00

(52) U.S. Cl. CPC H04N 1/00037; H04N 1/00013; H04N 1/00602

(57) ABSTRACT

An image reading apparatus includes a plurality of line image sensors, an upstream roller disposed upstream from the plurality of line image sensors, a downstream roller disposed downstream from the plurality of line image sensors, and a control unit that, in a case where detecting conveyance error by using the plurality of line image sensors, performs control such that in a first region of an original conveyed only by the upstream roller, the conveyance error is detected using read data from a line image sensor that is disposed close to the upstream roller, and in a third region of the original conveyed only by the downstream roller, the conveyance error is detected using read data from a line image sensor that is disposed close to the downstream roller.

### BACKGROUND OF THE DISCLOSURE

### Field of the Disclosure

The present disclosure relates to an image reading apparatus having a line image sensor.

### Description of the Related Art

In an image reading apparatus capable of reading large-format originals, using a long line image sensor for the line image sensor that reads the original is costly. A configuration that uses a plurality of small-sized line image sensors (“line sensors” hereinafter) is therefore generally employed. Because a plurality of line sensors are used, it is necessary to perform processing for stitching together the data read by each line sensor. At this time, eccentricity in original conveyance rollers will result in conveyance error, which produces error in the stitching processing.

FIGS. 22A and 22B illustrate a typical configuration of an image reading apparatus that uses a plurality of line sensors, and a reading example. As illustrated in FIG. 22A, an original 110 is conveyed by upstream rollers 107 and downstream rollers 108, and is read by a plurality of line sensors 106 arranged in a staggered manner. Processing for stitching together the results of the reading by the plurality of line sensors 106 at stitching positions 113 is then performed. At this time, if there is eccentricity in the upstream rollers 107 and the downstream rollers 108, error in the stitching positions will arise due to conveyance direction misalignment 2001 among the line sensors arranged in a staggered manner.

For example, if the line sensors 106 are disposed in a straight line, conveyance error of the conveyance rollers acts uniformly on all the line sensors, and thus error in the stitching positions is unlikely to occur. However, if misalignment 2001 among the line sensors is present in the conveyance direction, a difference in the conveyance amount will arise between the positions of the upstream-side line sensors and the positions of the downstream-side line sensors in the conveyance direction, resulting in stitching position error.

Specifically, as illustrated in FIG. 22B, when a straight line pattern 2002 is read, eccentricity of the upstream rollers 107 and the downstream rollers 108 results in the pattern being read as lines 2003 having different magnitudes of skew in the stitching positions for each of the straight lines.

To address such a problem, a technique is known in which an error component caused by eccentricity of an original conveyance roller at the time of reading is obtained in advance through processing called calibration, and the error component is corrected to achieve accurate stitching.

According to Japanese Patent Laid-Open No. 2021-061563, to perform calibration, a dot pattern formed on an original document is read, and an error component caused by eccentricity of the original conveyance roller is obtained on the basis of position data of the dot pattern that has been read.

According to Japanese Patent Laid-Open No. 2021-061563, in addition to an error component in the conveyance caused by eccentricity of the original conveyance roller, an error component in the conveyance caused by diameter error of the original conveyance roller is also obtained, by reading a similar dot pattern. This makes it possible to obtain an error component of the conveyance caused by eccentricity, diameter error, and the like of the original conveyance roller.

Meanwhile, in a typical sheet-feed type image reading apparatus, the original 110 is conveyed by the upstream rollers 107 disposed upstream in the conveyance direction of the original 110, and the downstream rollers 108 disposed downstream in the conveyance direction. There are thus three modes for conveying the original 110, namely conveyance using only the upstream rollers, conveyance using only the downstream rollers, and conveyance using both the upstream and downstream rollers. The influence of error is different in each conveyance mode, and it is therefore necessary to obtain the error component for each conveyance mode in order to obtain the error component produced by the original conveyance roller more accurately.

A problem such as that described hereinafter arises when obtaining an error component caused by the conveyance roller for each conveyance mode as described above. When conveying with an upstream roller and when conveying with a downstream roller, it is necessary to obtain the error component arising during conveyance using the conveyance roller on one side only. Conveyance error of a conveyance roller often occurs in a single cycle in a single revolution, as is the case with roller eccentricity and the like. As such, to improve the accuracy at which the error component is obtained, it is desirable that the distance conveyed by the conveyance rollers on only one side be equivalent to at least one revolution of the conveyance roller. However, to reduce the size of the image reading apparatus, it is necessary to shorten the interval between the respective conveyance rollers, and a section conveyed by the roller on one side only becomes shorter than one revolution of the roller. In this case, the error pattern cannot be read sufficiently well, which makes it difficult to accurately obtain the error component in conveyance caused by eccentricity, diameter error, and the like when conveying with an upstream roller and when conveying with a downstream roller.

### SUMMARY OF THE DISCLOSURE

Having been achieved in light of the foregoing issue, the present disclosure provides an image reading apparatus capable of accurately obtaining a conveyance error component caused by error in a conveyance roller.

According to a first aspect of the present disclosure, there is provided an image reading apparatus that conveys an original and reads the original, the image reading apparatus including a plurality of line image sensors disposed along a direction intersecting with a conveyance direction of the original, the line image sensors being disposed in a staggered manner shifted from each other alternately in the conveyance direction by a predetermined amount; an upstream roller disposed upstream from the plurality of line image sensors in the conveyance direction of the original; a downstream roller disposed downstream from the plurality of line image sensors in the conveyance direction of the original; and at least one processor configured to function as: a control unit that, in a case where detecting conveyance error by using the plurality of line image sensors to read an original on which is formed a detection pattern for detecting conveyance error of the upstream roller and the downstream roller, performs control such that in a first region of the original conveyed only by the upstream roller, the conveyance error is detected using read data from a line image sensor, among the line image sensors disposed in a staggered manner, that is disposed close to the upstream roller, and in a third region of the original conveyed only by the downstream roller, the conveyance error is detected using read data from a line image sensor, among the line image sensors disposed in a staggered manner, that is disposed close to the downstream roller.

According to a second aspect of the present disclosure, there is provided a control method for an image reading apparatus that conveys an original and reads the original. The image reading apparatus including a plurality of line image sensors disposed along a direction intersecting with a conveyance direction of the original, the line image sensors being disposed in a staggered manner shifted from each other alternately in the conveyance direction by a predetermined amount; an upstream roller disposed upstream from the plurality of line image sensors in the conveyance direction of the original; and a downstream roller disposed downstream from the plurality of line image sensors in the conveyance direction of the original. The control method including performing control, in a case where detecting conveyance error by using the plurality of line image sensors to read an original on which is formed a detection pattern for detecting conveyance error of the upstream roller and the downstream roller, such that in a first region of the original conveyed only by the upstream roller, the conveyance error is detected using read data from a line image sensor, among the line image sensors disposed in a staggered manner, that is disposed close to the upstream roller, and in a third region of the original conveyed only by the downstream roller, the conveyance error is detected using read data from a line image sensor, among the line image sensors disposed in a staggered manner, that is disposed close to the downstream roller.

Further features of the present disclosure will become apparent from the following description of exemplary embodiments with reference to the attached drawings.

### BRIEF DESCRIPTION OF THE DRAWINGS

FIGS. 1A to 1C are diagrams illustrating the overall configuration of an image reading apparatus according to a first embodiment.

FIG. 2 is a block diagram illustrating the hardware configuration of the image reading apparatus.

FIG. 3 is a flowchart illustrating calibration processing by the image reading apparatus.

FIG. 4 is a diagram illustrating a pattern for correction value obtainment processing.

FIG. 5 is a flowchart illustrating the correction value obtainment processing.

FIG. 6 is a diagram illustrating a circular dot pattern to be read.

FIG. 7 is a flowchart illustrating processing for obtaining center coordinates of the circular dot pattern.

FIGS. 8A to 8C are diagrams illustrating a relationship between a conveyance mode of an original conveyance roller and line image sensors.

FIGS. 9A to 9D are diagrams illustrating a relationship between (i) upstream CISs and downstream CISs arranged in a staggered manner and (ii) a conveyance length.

FIGS. 10A and 10B are diagrams illustrating a relationship between (i) upstream CISs and downstream CISs arranged in a staggered manner and (ii) a conveyance length.

FIG. 11 is a flowchart illustrating conveyance error obtainment processing.

FIG. 12 is a flowchart illustrating processing for determining a target CIS and a roller conveyance region.

FIG. 13 is a flowchart illustrating sub scanning direction magnification obtainment processing.

FIGS. 14A and 14B are conceptual diagrams illustrating dot patterns and dot pattern reading results.

FIG. 15 is a diagram illustrating coordinate transformation.

FIG. 16 is a flowchart illustrating eccentricity error suppression processing.

FIG. 17 is a diagram illustrating a relationship between a conveyance amount Δy per unit section and a cumulative added value y thereof.

FIGS. 18A and 18B are diagrams illustrating an issue arising when obtaining conveyance error according to a second embodiment.

FIGS. 19A and 19B are flowcharts illustrating conveyance error obtainment processing.

FIG. 20 is a flowchart illustrating conveyance error supplementation processing.

FIGS. 21A to 21C are diagrams illustrating a method for comparing conveyance error.

FIGS. 22A and 22B are diagrams illustrating a typical configuration of an image reading apparatus having a plurality of line image sensors, and an example of a reading result.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### First Embodiment

The present embodiment will describe processing for obtaining conveyance error in a sheet-feed type image reading apparatus having a plurality of line image sensors, for a conveyance mode in which an original is conveyed by only an upstream roller disposed upstream in the conveyance direction of the original, a conveyance mode in which the original is conveyed by both upstream and downstream rollers, and a conveyance mode in which the original is conveyed by only a downstream roller disposed downstream in the conveyance direction of the original.

The following will refer to the conveyance mode in which the original is conveyed by only the upstream roller as a “first conveyance mode”, the conveyance mode in which the original is conveyed by both the upstream and downstream rollers as a “second conveyance mode”, and the conveyance mode in which the original is conveyed by only the downstream roller as a “third conveyance mode”. “Processing for obtaining conveyance error” refers to processing for calculating a correction value for correcting an error component in the conveyance of an original, caused by eccentricity, diameter error, and the like of an original conveyance roller.

“Conveyance error caused by eccentricity of an original conveyance roller” specifically refers to the variation in the amount by which the original is conveyed per unit of rotation angle, which occurs when the axis of the original conveyance roller is slightly skewed from the center thereof due to manufacturing tolerances. The conveyance amount in a unit section may be higher or lower depending on the position, and the amount of conveyance error caused by eccentricity of the original conveyance roller changes over a cycle corresponding to one revolution of the roller, becoming zero when one revolution's worth of the roller is added up.

Additionally, “conveyance error caused by diameter error of an original conveyance roller” specifically refers to variation in the amount by which the original is conveyed when the diameter of the original conveyance roller varies due to manufacturing tolerances. The amount of conveyance error caused by diameter error of the original conveyance roller is affected equally in the entire region conveyed by the original conveyance roller, and thus a change in the magnification of the read image in the conveyance direction is produced. In the processing of obtaining the correction value, the correction value is obtained from the result of reading a specific pattern (a detection pattern) in advance.

### Configuration of Image Reading Apparatus

The basic configuration of the image reading apparatus will be described first with reference to an overall diagram of the image reading apparatus, a diagram illustrating a mode for reading an image, and the like.

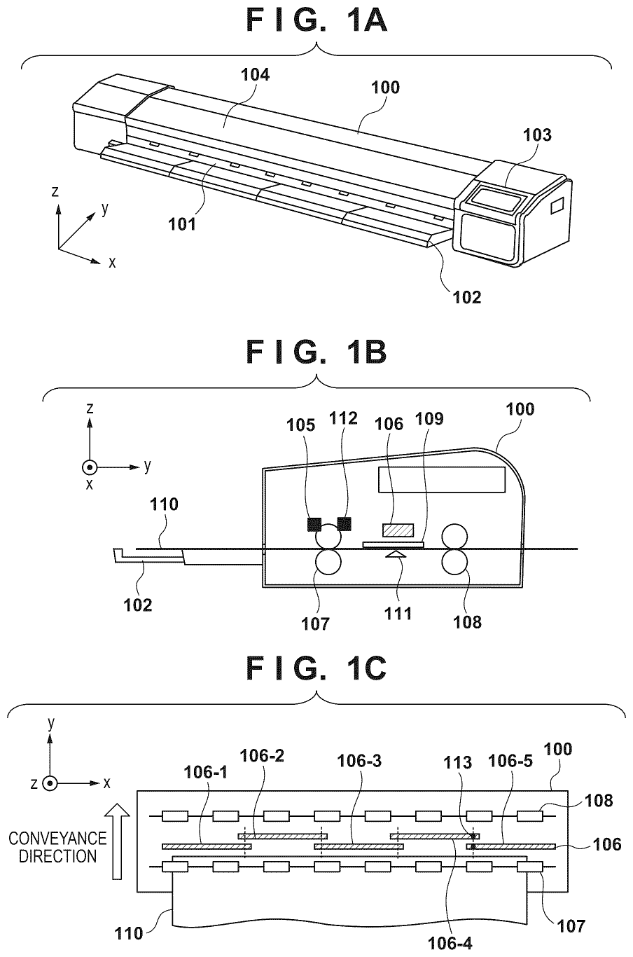

FIG. 1A is a perspective view illustrating the external appearance of a sheet-feed type scanner 100, which is an example of the image reading apparatus according to the present disclosure. As illustrated in FIG. 1A, the scanner 100 includes an original sheet feed port 101 and an original sheet feed platform 102 on a front side of a main body. A user inserts a leading end of the original into the original sheet feed port 101 by placing the leading end of the original on the original sheet feed platform 102 such that a center part of the original is positioned at the center of the sheet feed port, and sliding the original upon the platform. The original sheet feed port 101 is designed such that misalignment, angling of the original, and the like during insertion, with respect to the width of a main scanning direction of the original that can be read by the scanner 100, are allowable to a certain extent. The configuration of a sheet feed path for the original will be described later with reference to FIG. 1B. Note that to simplify the descriptions, coordinate axes are set as indicated in FIG. 1A, and these coordinate axes are assumed to apply to the other figures as well.

The scanner 100 includes an operation unit 103 constituted by physical keys, a touch panel, an LCD panel, or the like provided on an upper surface of the main body, and reading conditions, the size of the original, and the like can be entered therein. An upper cover 104 is provided on the upper surface of the scanner 100, and a reading unit and the like can be accessed by opening the upper cover 104 upward. This makes it possible to perform maintenance on the main body.

FIGS. 1B and 1C are schematic diagrams illustrating the internal configuration of the scanner 100, where FIG. 1B is a cross-sectional view and FIG. 1C is a top view. In the cross-sectional view in FIG. 1B, the left side corresponds to an upstream side in the feeding of the original and the right side corresponds to a downstream side. The original is conveyed in a ty direction. The original 110, which is supplied by the user via the original sheet feed platform 102, is discharged from a rear surface of the main body through a flat conveyance path.

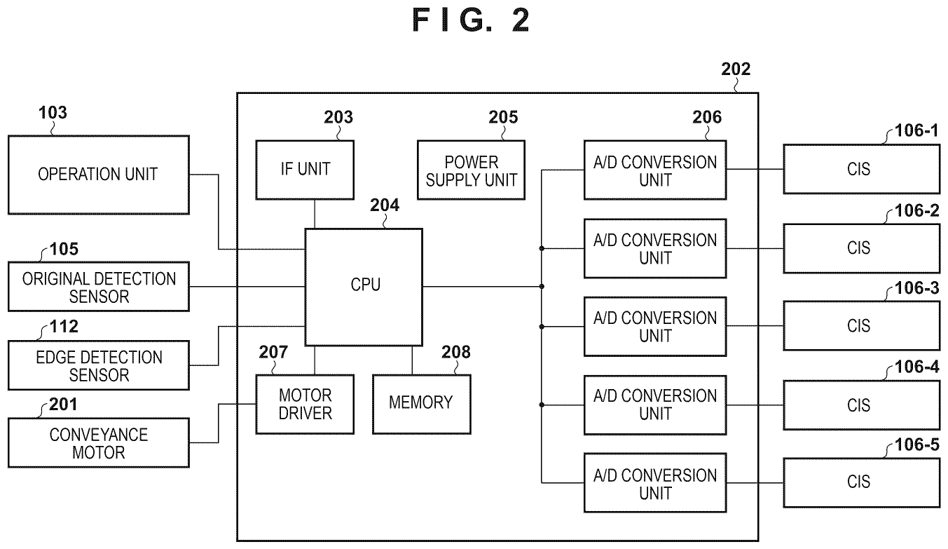

An original detection sensor 105 detects the insertion of the original 110. When the insertion of the original 110 is detected, a control unit 202 (see FIG. 2) of the scanner 100 causes upstream rollers 107 to rotate so as to draw the original 110 into the main body. An end detection sensor 112 is used to detect the leading end of the original 110 pulled into the main body by the rotation of the upstream rollers 107. A detection result from the end detection sensor 112 is also used to determine a reading start position for the original 110, to detect the position of a following end of the original 110, and the like.

Within the main body, the original 110 passes between a glass plate 109 and an original pressure plate 111. The original pressure plate 111 presses the original 110 against the glass plate 109 at a predetermined pressure. Line image sensors (“CISs” hereinafter) 106 are line image sensors in which light-receiving elements are arranged in the main scanning direction (the x direction, in the figures), which is a direction orthogonal to (intersecting with) the conveyance direction of the original 110. Each is constituted by a plurality of chips which are in turn constituted by a plurality of light-receiving elements. A reading surface of each CIS 106 faces the glass plate 109, and a focal position of the reading is designed to be located at a plane where the original 110 and the glass plate 109 are in contact with each other.

The downstream rollers 108 are configured to be driven by the upstream rollers 107 using a belt (not shown), and have a function for discharging the original, which has exited the region where the original is pressed against the glass plate 109 by the original pressure plate 111, toward the downstream side. The control unit 202 (described later) is constituted by motors (not shown) for driving the detection sensors and rotating the upstream rollers 107, a circuit board for controlling the CISs 106 and the operation unit 103, and the like.

As illustrated by the top view in FIG. 1C, the scanner 100 is configured such that a plurality of the CISs 106 are disposed in the main scanning direction in a staggered manner (shifted from each other by a predetermined amount in a sub scanning direction) (in this example, five are disposed, indicated by 106-1 to 106-5). In the scanner 100, the original 110 is read by each CIS 106, and processing for stitching together the data read by the CISs 106-1 to 106-5 at stitching positions 113 is performed by the control unit 202.

FIG. 2 is a block diagram illustrating the hardware configuration of the scanner 100 according to the present embodiment. In the scanner 100, the control unit 202, which controls image reading and the like, includes a CPU 204, a memory 208, a motor driver 207, an interface (“IF” hereinafter) unit 203, A/D conversion units 206, and a power supply unit 205. The operation unit 103 is constituted by a touch panel including a liquid-crystal display (LCD). Information pertaining to the original to be read, the settings of the reading apparatus, and the like are displayed in the LCD of the operation unit 103 in accordance with instructions from the CPU 204. The user can also make inputs to the scanner 100, e.g., change various settings, by operating the touch panel on the operation unit 103 while confirming the information displayed in the LCD of the operation unit 103.

A conveyance motor 201 is controlled by the CPU 204 through the motor driver 207, and causes the upstream rollers 107 and the downstream rollers 108 to rotate. Outputs from an original detection sensor 105 and an end detection sensor 112 are input to the CPU 204, and the CPU 204 performs control, such as determining driving timings for the plurality of CISs 106-1 to 106-5, on the basis of changes in output signals from these sensors and the state of the conveyance motor 201.

Each of the plurality of CISs 106 outputs the read image as an analog signal to the control unit 202. The analog signals output from the plurality of CISs 106 are converted into digital signals by corresponding ones of the A/D conversion units 206, and the digital signals are input to the CPU 204. The CPU 204 can process the data converted into digital signals by the A/D conversion units 206 and send that data as image data to an external device connected through a USB connection, a LAN, or the like via the IF unit 203. The power supply unit 205 generates a voltage required by each part and supplies power thereto. The memory 208 can store a plurality of lines' worth of image data.

### Calibration

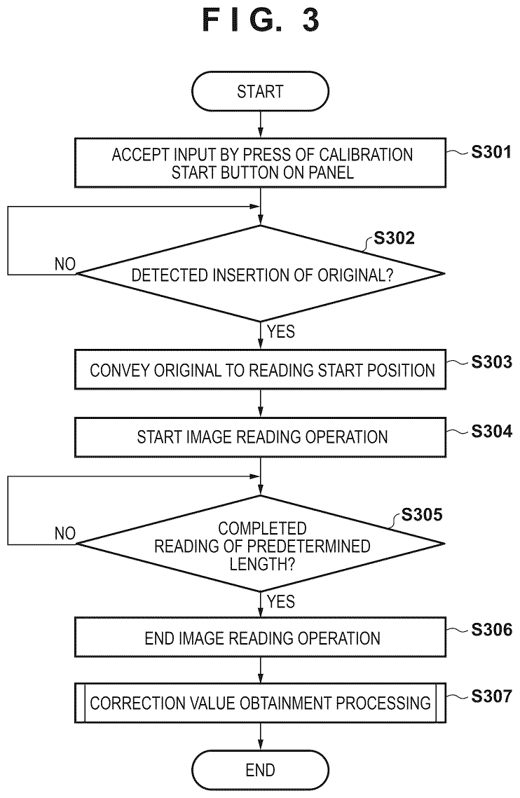

A flow through which an original 110 on which a pattern for correction value obtainment processing (also called a “calibration chart”) has been formed is read using the CISs 106, and a correction value is obtained, will be described hereinafter with reference to the flowchart in FIG. 3. Note that the timing at which the correction value is obtained may be in advance, or the correction value may be obtained with each reading.

If the correction value is obtained in advance, the correction value is obtained by reading a predetermined original, prepared in advance, when shipping from the factory or at the user's location. The same correction value is then applied in each reading. In this case, it is not necessary to obtain the correction value with each reading, which makes it possible to shorten the reading time.

On the other hand, if the correction value is obtained with each reading, the correction value is obtained by reading a predetermined original prior to the reading, or by reading an original in which a pattern for obtaining the correction value is printed in a header part of the original. In this case, the current error component can be corrected each time, which makes it possible to achieve highly-accurate reading.

First, in step S301, the CPU 204 accepts an input made by the user pressing a calibration start button on the operation unit 103. As a result, the scanner 100 enters a state of standing by for the insertion of a dedicated original to be used for calibration. Hereinafter, “step S . . . ” will be shortened to simply “S . . . ” to simplify the descriptions.

In S302, the CPU 204 determines whether the insertion of the original 110 set by the user has been detected. If the original 110 has been inserted, the sequence moves to S303. However, if the original 110 has not been inserted, the determination for detecting whether the original 110 has been inserted is repeated.

In S303, the CPU 204 conveys the original 110 to a reading start position by controlling the conveyance motor 201.

In S304, the CPU 204 starts an image reading operation, and saves the data obtained through the reading (called “read data” hereinafter) in the memory 208.

In S305, the CPU 204 determines whether reading of a predetermined length is complete. If the reading of the predetermined length is complete, the sequence moves to S306. However, if the reading of the predetermined length is not complete, the reading operation continues until the reading of the predetermined length is complete.

In S306, the CPU 204 ends the image reading operation, and causes the original 110 for calibration to be conveyed to a discharge position.

In S307, the CPU 204 performs correction value obtainment processing. The correction value obtained in this step is stored in the memory 208, and is read out and applied during a normal reading operation.

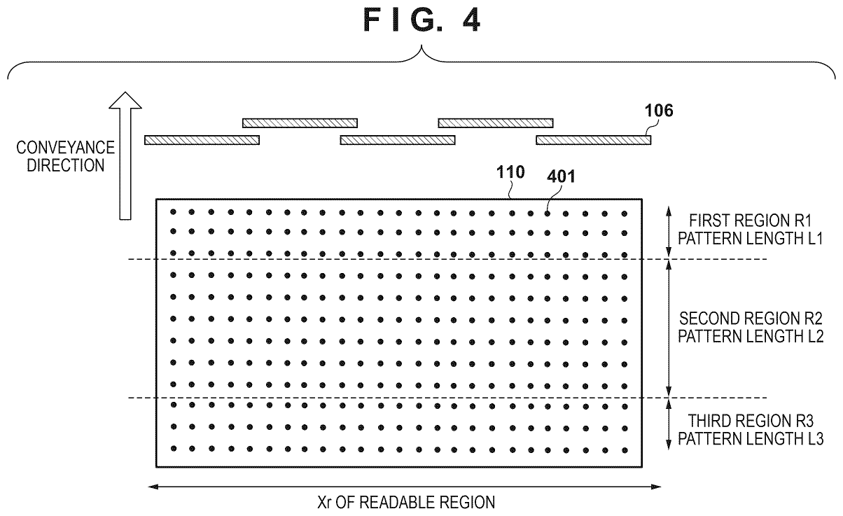

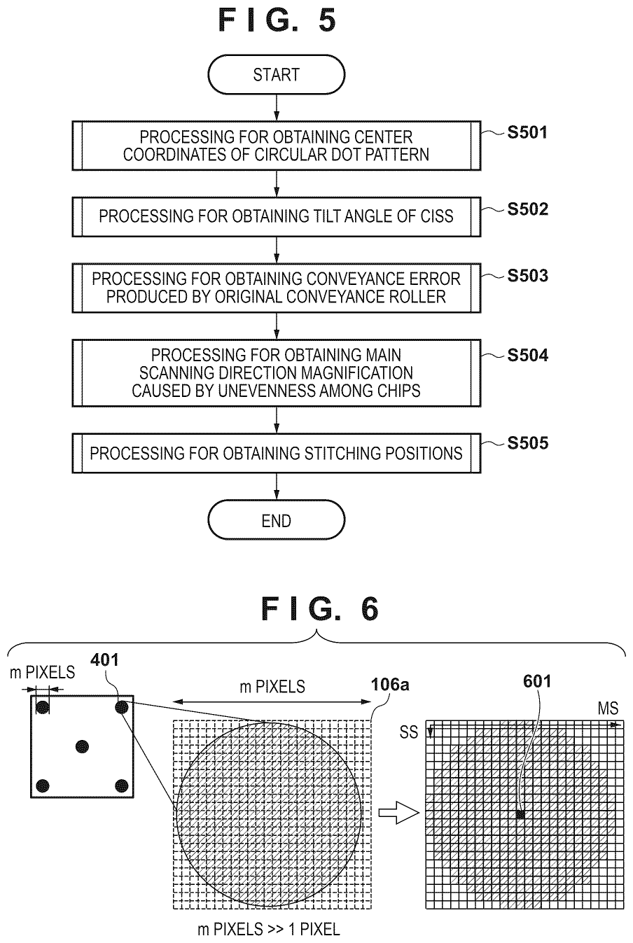

A flow through which the correction value is obtained on the basis of a pattern that has been read (details of S307 of FIG. 3) will be described next with reference to FIGS. 4 and 5. FIG. 4 is a diagram illustrating an original on which a pattern for the correction value obtainment processing (the calibration chart) according to the present embodiment has been formed.

As illustrated in FIG. 4, a plurality of circular dot patterns 401, each constituted by a plurality of dots (a pixel value of 1), are printed in the calibration chart so as to be separated from each other, and the circular dot patterns 401 are read while the original is being conveyed using an original conveyance roller.

In FIG. 4, an upstream roller conveyance region (“first region R1” hereinafter) is a region read by the CISs 106 when the original is conveyed by the upstream rollers 107 only (the first conveyance mode). An upstream and downstream roller conveyance region (“second region R2” hereinafter) is a region read by the CISs 106 when the original is conveyed by both the upstream rollers 107 and the downstream rollers 108 (the second conveyance mode). A downstream roller conveyance region (“third region R3” hereinafter) is a region read by the CISs 106 when the original is conveyed by the downstream rollers 108 only (the third conveyance mode).

The plurality of circular dot patterns 401 are formed over a range corresponding to a width Xr of a readable region, a pattern length L1 of the first region R1, a pattern length L2 of the second region R2, and a pattern length L3 of the third region R3. For example, conveyance error caused by eccentricity of the original conveyance roller changes in a cycle corresponding to one revolution of the original conveyance roller. Accordingly, to obtain the data of one cycle of the conveyance error, it is desirable that the pattern length L1 of the first region R1, the pattern length L2 of the second region R2, and the pattern length L3 of the third region R3 each be set to a length that is at least a circumferential length Yr of one revolution of the original conveyance roller. However, reducing the size of the apparatus makes it difficult to make the pattern lengths L1 to L3 of the regions, and L1 and L3 in particular, at least as long as the circumferential length Yr of one revolution of the original conveyance roller. The present embodiment will describe a method for solving this problem.

First, in S501, the CPU 204 obtains center coordinates of the circular dot patterns 401. Specifically, the center coordinates of each of the circular dot patterns 401 are obtained from the read data obtained from reading the image. The center coordinates obtained in this step are used in processing for obtaining each of correction values (described later).

In S502, the CPU 204 performs processing for obtaining a tilt angle of the CISs 106. Specifically, the tilt angle is obtained using the fact that the plurality of circular dot patterns are arranged concentrically such that a sum of the coordinates from reference coordinates is 0. The processing for obtaining the tilt angle in this step is processing for suppressing skew in the stitching positions 113 when the read data is stitched together. Information of the tilt angle of the CISs 106 found in this step makes it possible to stitch the read images together with high accuracy at a later time. In the processing for obtaining each of the correction values (described later), the correction values according to the tilt angle of the CISs 106 obtained in S502 are applied in advance, after which the processing is performed.

In S503, the CPU 204 performs processing for obtaining conveyance error caused by eccentricity, diameter error, and the like of the original conveyance roller. The obtainment method will be described in detail later.

In S504, the CPU 204 performs processing for obtaining main scanning direction magnification caused by unevenness among the chips in the CISs 106. The processing for obtaining the main scanning direction magnification caused by unevenness among the chips is processing for correcting reading error in the main scanning direction caused by gaps between the chips within the CIS 106.

In S505, the CPU 204 performs processing for obtaining the stitching positions. The processing for obtaining the stitching positions is processing for performing accurate stitching of the reading results from the CISs 106, and is processing for applying the correction values obtained from the results of S502 to S504 in advance and obtaining the stitching positions 113. This completes the calibration involving the obtainment of the respective correction values.

The processing performed in each of the foregoing steps will be described in more detail hereinafter.

### Center Coordinate Obtainment Processing

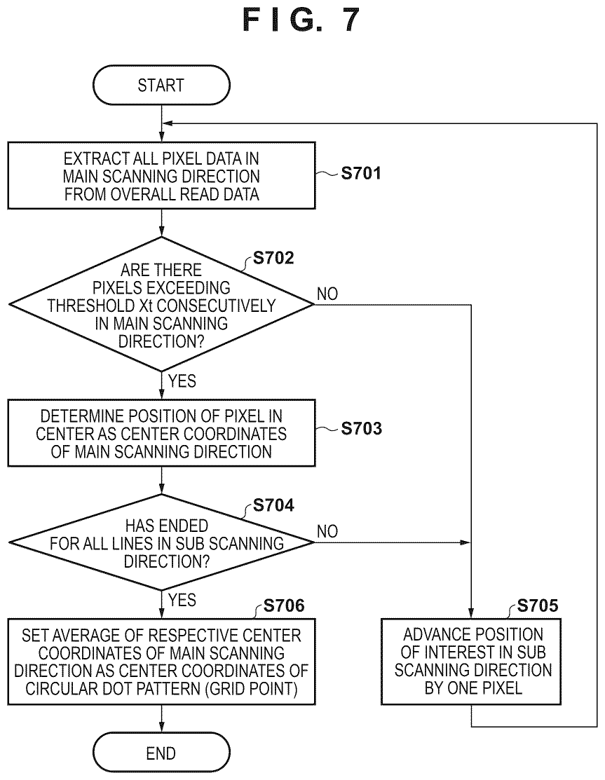

Processing for obtaining the center coordinates of the circular dot patterns on the basis of the read data (S501 of FIG. 5) will be described in detail hereinafter with reference to the circular dot patterns 401 illustrated in FIG. 6 and the flowchart illustrated in FIG. 7. As illustrated in FIG. 6, it is necessary for the circular dot pattern 401 to be a pattern that is somewhat larger than a pixel 106a to be read by the scanner.

First, in S701, the CPU 204 extracts, from the overall read data, all pixel data, in a main scanning direction MS of the CISs 106, at a position of interest (the position of a pixel line of interest) in a sub scanning direction SS of the CISs 106.

In S702, the CPU 204 determines, on the basis of the pixel data extracted in S701, whether pixels having tone values exceeding a threshold Xt are present consecutively in the main scanning direction MS, and then binarizes each pixel as indicated in FIG. 6. The sequence moves to S703 if pixels having tone values exceeding the threshold Xt are present consecutively in the main scanning direction MS, and to S705 if not. Note that the threshold Xt used in this step is set in advance, and the data thereof is stored in the memory 208.

In S703, the CPU 204 determines the position of the pixel in the center of the consecutive pixels having tone values exceeding the threshold Xt as the center coordinates of the main scanning direction MS.

In S704, the CPU 204 determines whether the obtainment of the center coordinates of the main scanning direction MS has ended for all pixel lines in the sub scanning direction SS.

In S705, the CPU 204 advances the position of interest (the position of the pixel line of interest) in the sub scanning direction SS by one pixel (one line).

In S706, the CPU 204 obtains the average of the obtained center coordinates of the main scanning direction MS, and sets the obtained average as center coordinates 601 of the circular dot pattern 401.

Note that reading error arising due to debris when obtaining the center coordinates of the main scanning direction MS can be taken into account by enlarging the dot pattern. Additionally, when taking into account reading error caused by gaps between the chips of the CISs 106, it is necessary to obtain the center coordinates having selected a location that does not span two chips when obtaining the coordinates of the main scanning direction MS.

Note that it is desirable that the shape of the dot pattern be substantially circular, as illustrated in FIG. 6. The reason for this is that a substantially circular shape is less susceptible to the influence of error components during reading when obtaining the center coordinates 601. For example, when the original is set in a tilted manner, if the shape of the dot pattern is square, it is difficult to determine whether the pixel data in the main scanning direction MS includes pixels having tone values exceeding the threshold Xt consecutively in the main scanning direction MS. Substantially circular shapes make it easier to determine pixel data in which the tone values exceed the threshold Xt consecutively in the main scanning direction MS.

Furthermore, when the dot pattern is substantially circular, it is not necessary to perform the processing for obtaining the center coordinates for all the lines in the sub scanning direction SS, as in S704 to S706 of FIG. 7. In other words, assuming that the dot patterns are substantially circular, pixel data having tone values exceeding the threshold Xt consecutively in the main scanning direction MS can be inferred in order to obtain the center coordinates 601 of the dot pattern. This makes it possible to shorten the time required to obtain the center coordinates.

### Processing for Obtaining Conveyance Error Caused by Error of Original Conveyance Roller

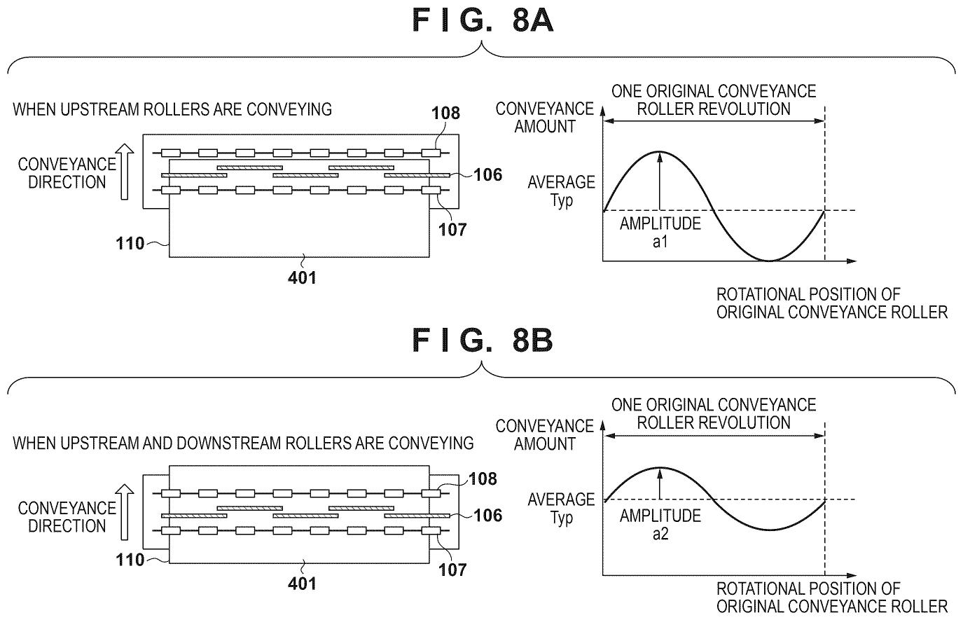

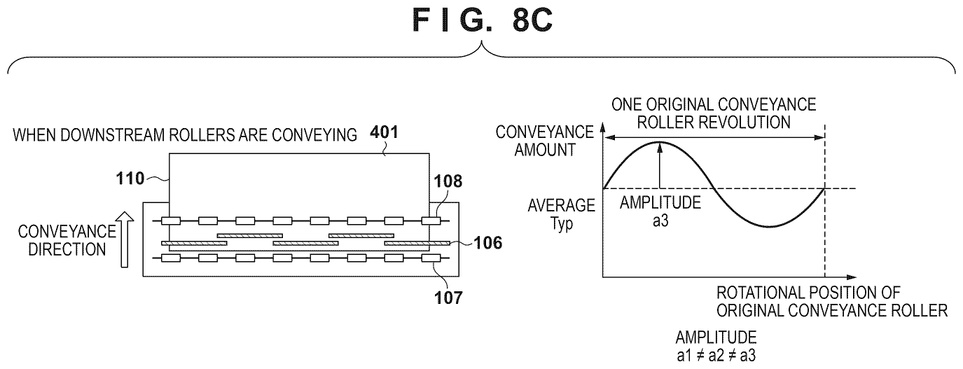

A method for obtaining the conveyance error caused by the error of the original conveyance roller according to the present embodiment will be described hereinafter with reference to FIGS. 8A to 12.

FIGS. 8A to 10B are diagrams illustrating a relationship between the conveyance mode of the original conveyance roller and the line image sensors.

FIG. 8A illustrates the first conveyance mode, FIG. 8B illustrates the second conveyance mode, and FIG. 8C illustrates the third conveyance mode.

As already described with reference to FIG. 4, the first conveyance mode is a mode in which the original is conveyed by the upstream rollers 107 only, and the second conveyance mode is a mode in which the original is conveyed by both the upstream rollers 107 and the downstream rollers 108. The third conveyance mode is a mode in which the original is conveyed by the downstream rollers 108 only.

The effect of eccentricity, diameter error, and the like of the original conveyance roller on conveyance error is different in each conveyance mode. The graphs on the right side of FIGS. 8A to 8C illustrate changes in the conveyance amount due to the rotational position of the roller, with the rotational position of the original conveyance roller represented by the horizontal axis and the conveyance amount represented by the vertical axis.

In FIGS. 8A to 8C, the amplitude of the change in the conveyance amount differs depending on the conveyance mode, as indicated by amplitudes a1 to a3. When the conveyance error is obtained in the first conveyance mode, as in FIG. 8A, and the reading error is corrected on the basis of the conveyance error, the conveyance error is different in the case of the second conveyance mode and the third conveyance mode, and thus correction error arises. Accordingly, in each conveyance mode, the reading error can be corrected more accurately by obtaining conveyance error caused by eccentricity, diameter error, and the like of the original conveyance roller.

Here, when obtaining the conveyance error in each conveyance mode, it is desirable that the length conveyed in each conveyance mode be longer than a single revolution of the original conveyance roller. However, to reduce the size of the image reading apparatus, it is necessary to shorten the interval between the upstream rollers 107 and the downstream rollers 108 in the conveyance direction. As such, while the method works properly for the second conveyance mode, it is difficult to ensure the length conveyed is longer than one revolution of the original conveyance roller in the first conveyance mode and the third conveyance mode.

A configuration of the present embodiment for solving this problem will be described hereinafter.

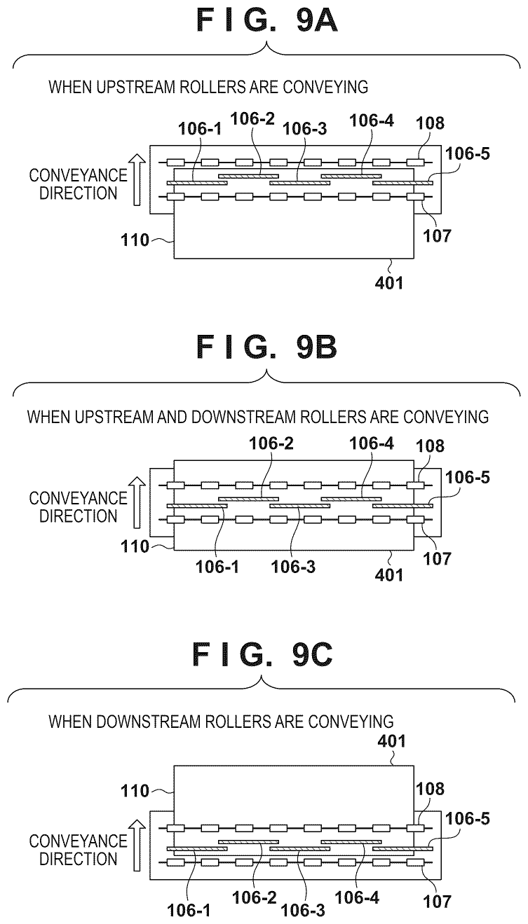

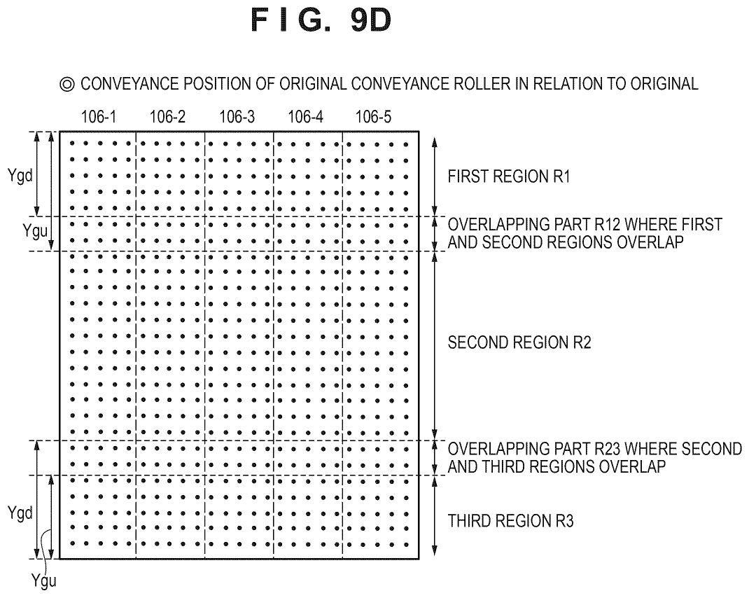

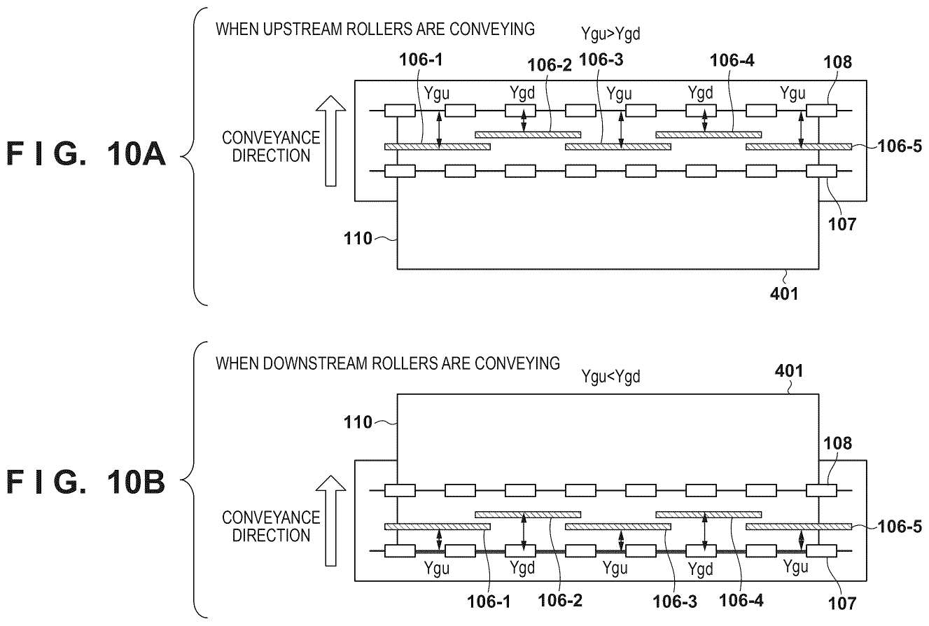

FIGS. 9A to 9D, 10A, and 10B are diagrams illustrating a relationship

between (i) upstream CISs and downstream CISs arranged in a staggered manner and (ii) a conveyance length.

Although already described with reference to FIG. 4, the first region R1 is a region read by the CISs 106 when the original is conveyed by the upstream rollers 107 only (the first conveyance mode) in FIGS. 9A to 9D as well. The second region R2 is a region read by the CISs 106 when the original is conveyed by both the upstream rollers 107 and the downstream rollers 108 (the second conveyance mode). The third region R3 is a region read by the CISs 106 when the original is conveyed by the downstream rollers 108 only (the third conveyance mode).

In this case, as illustrated in FIG. 9D, for the first region R1, upstream CISs 106-1, 106-3, and 106-5 and downstream CISs 106-2 and 106-4 all read the original conveyed by the upstream rollers only (that is, in the first conveyance mode).

In contrast, for an overlapping part R12 where the first and second regions overlap, the upstream CISs 106-1, 106-3 and 106-5 read the original conveyed by the upstream rollers only, but the downstream CISs 106-2 and 106-4 read the original conveyed by both the upstream rollers and the downstream rollers. In this manner, for the overlapping part R12, the conveyance mode is different between when reading using the upstream CISs 106-1, 106-3 and 106-5 and when reading using the downstream CISs 106-2 and 106-4.

In other words, for the upstream CISs 106-1, 106-3 and 106-5, a region which is a combination of the first region R1 and the overlapping part R12 (a region of a length Ygu in FIGS. 9A to 9D, 10A, and 10B) can be conveyed and read in the first conveyance mode. In other words, the length of the region conveyed in the first conveyance mode can be made longer than with the downstream CISs 106-2 and 106-4, which can only read the first region R1 (a region of a length Ygd in FIGS. 9A to 9D, 10A, and 10B) in the first conveyance mode. As a result, the length of the region conveyed in the first conveyance mode can easily be made longer than one revolution of the original conveyance roller.

Accordingly, in the present embodiment, when reading the region conveyed in the first conveyance mode, the data for the first conveyance mode can be obtained over a longer range by using the data from the upstream CISs 106-1, 106-3, and 106-5. Note that in this case, the data from the downstream CISs 106-2 and 106-4 for the first conveyance mode is not used.

Similarly, for the third region R3 illustrated in FIG. 9D, the upstream CISs 106-1, 106-3, and 106-5 and downstream CISs 106-2 and 106-4 all read the original conveyed by the downstream rollers (that is, in the third conveyance mode).

In contrast, for an overlapping part R23 where the second and third regions overlap, the downstream CISs 106-2 and 106-4 read the original conveyed by the downstream rollers only, but the upstream CISs 106-1, 106-3 and 106-5 read the original conveyed by both the upstream rollers and the downstream rollers. In this manner, for the overlapping part R23, the conveyance mode is different between when reading using the upstream CISs 106-1, 106-3 and 106-5 and when reading using the downstream CISs 106-2 and 106-4.

In other words, for the downstream CISs 106-2 and 106-4, a region which is a combination of the third region R3 and the overlapping part R23 (the region of the length Ygd in FIGS. 9A to 9D, 10A, and 10B) can be conveyed and read in the third conveyance mode. In other words, the length of the region conveyed in the third conveyance mode can be made longer than with the upstream CISs 106-1, 106-3 and 106-5, which can only read the third region R3 (the region of the length Ygu in FIGS. 9A to 9D, 10A, and 10B) in the third conveyance mode. As a result, the length of the region conveyed in the third conveyance mode can easily be made longer than one revolution of the original conveyance roller.

Accordingly, in the present embodiment, when reading the region conveyed in the third conveyance mode, the data for the third conveyance mode can be obtained over a longer range by using the data from the downstream CISs 106-2 and 106-4. Note that in this case, the data from the upstream CISs 106-1, 106-3, and 106-5 for the third conveyance mode is not used.

Note that as described above, rather than switching the data to be used after the reading by all the CISs 106, the configuration may be such that when performing the image reading operations in S304 to S306, the CISs 106 that perform the reading operations are switched for each conveyance mode. For example, when conveying the upstream roller conveyance region (the first conveyance mode), the reading operations are performed by the upstream CISs only, whereas when conveying the downstream roller conveyance region (the third conveyance mode), the reading operations are performed by the downstream CISs only. Based on this, it is possible to obtain the conveyance error of the original conveyance rollers with high accuracy, for each conveyance mode.

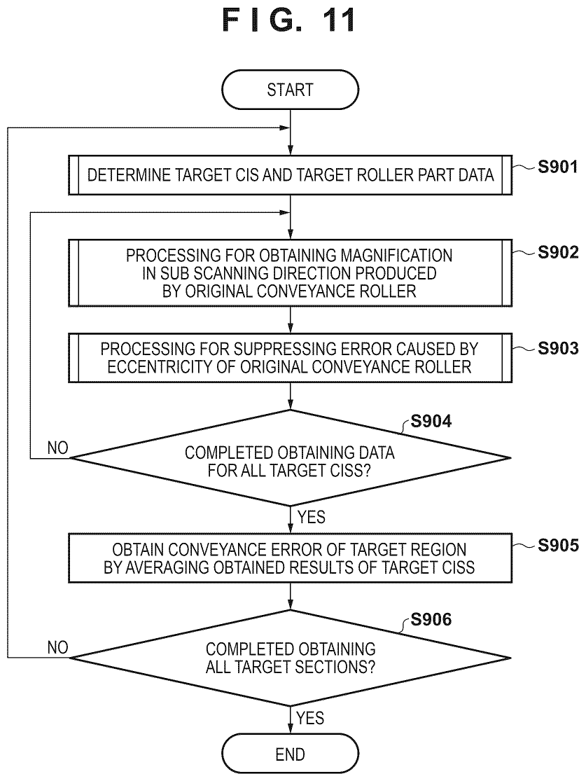

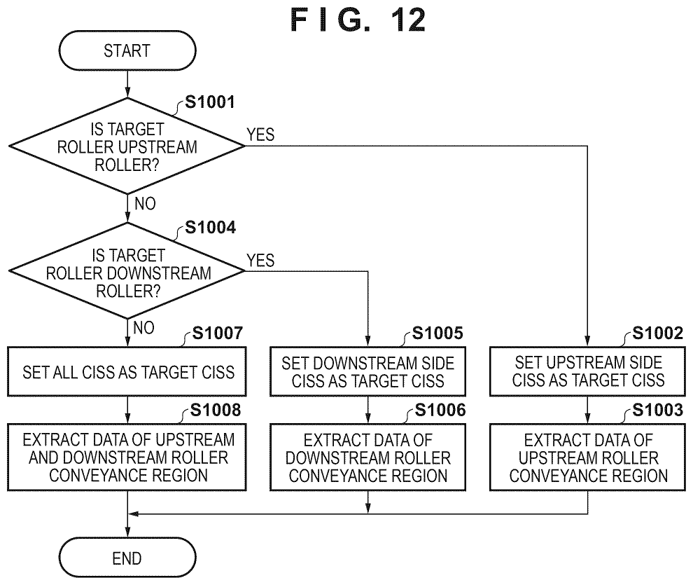

Next, flows for obtaining the conveyance error of the original conveyance rollers with high accuracy for each conveyance mode will be described with reference to the flowcharts in FIGS. 11 and 12.

FIG. 11 is a diagram illustrating processing for obtaining conveyance error produced by the original conveyance roller, and is a flowchart illustrating details of the conveyance error obtainment processing in S503 of FIG. 5.

In S901, the CPU 204 determines a target CIS 106 and a target reading region, for each conveyance mode. In this step, the upstream roller conveyance region (the first region), the upstream and downstream roller conveyance region (the second region), and the downstream roller conveyance region (the third region) are determined, and data is extracted for each conveyance mode. This flow will be described in detail later.

In S902, the CPU 204 performs processing for obtaining magnification in the sub scanning direction produced by the original conveyance roller, for the target CISs 106 and target data. The processing for obtaining the magnification in the sub scanning direction produced by the original conveyance roller is processing for obtaining the magnification in the sub scanning direction caused by diameter error of the original conveyance roller, which affects the overall reading result of the scanner 100. This obtainment processing will be described in detail later.

In S903, the CPU 204 performs processing for suppressing the effect of eccentricity of the original conveyance roller on the target CISs 106 and the target data. This step is processing for correcting reading error in the sub scanning direction caused by eccentricity of the original conveyance roller, which affects the overall reading result of the scanner 100, by determining an eccentricity rate of the original conveyance roller, for example. This obtainment processing will be described in detail later.

In S904, the CPU 204 determines whether processing for obtaining the data for all target CISs 106 is complete. If the obtainment of the data for all target CISs 106 is not complete, the sequence returns to S902, and the remaining CISs 106 are processed.

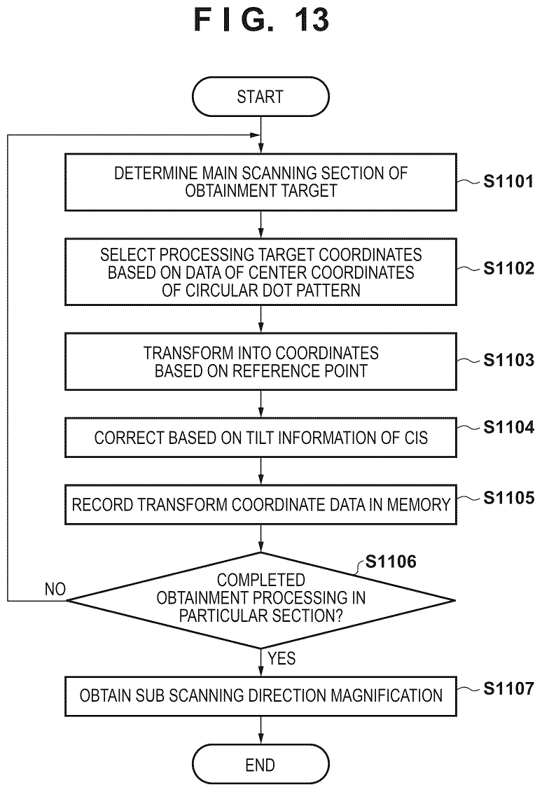

In S905, the CPU 204 averages the results obtained for each of the target CISs 106 and holds that average as the conveyance error of the target region. Note that the results obtained for each of the target CISs 106 may be either the result of averaging the correction values obtained in S1107 of FIG. 13 and S1403 of FIG. 16, or the result of averaging based on transform coordinate data in S1105 of FIG. 13, which will be described later. If the transform coordinate data in S1105 of FIG. 13 is averaged, the correction value is obtained after the averaging through processing similar to that performed in S1107 of FIG. 13, S1401 to S1403 of FIG. 16, and the like.

In S906, the CPU 204 determines whether the obtainment of data is complete for all target sections in the upstream roller conveyance region (the first region), the upstream and downstream roller conveyance region (the second region), and the downstream roller conveyance region (the third region). If the obtainment is not complete for all the target sections, the sequence returns to S901, and the remaining target sections are processed.

FIG. 12 is a diagram illustrating data determination processing performed for the target CIS and the target region in S901 of FIG. 11.

In S1001, the CPU 204 determines whether the target roller is an upstream roller. Based on the flow of the data, it is desirable that the order in which the target rollers are determined is the order of the upstream roller, the upstream and downstream rollers, and the downstream roller, but a different order may be used. The CPU 204 moves the sequence to S1002 if the target roller is the upstream roller, and to S1004 if not.

In S1002, the CPU 204 sets the upstream CISs 106-1, 106-3, and 106-5 as the target CISs 106.

In S1003, the CPU 204 extracts the data of the upstream roller conveyance region (the first region) from all of the read data of the target CISs 106. As an extraction method, the extraction is performed from the number of read lines in the data obtained by reading the original 110 on which the dot pattern 401 is formed. The data is extracted from a number of lines corresponding to the section being conveyed by the upstream rollers 107, taking the data at the end of the original 110 as a reference. Note, however, that the method is not limited thereto, and the extraction may be performed, for example, on the basis of the timing at which the end detection sensor 112 detects the original 110.

In S1004, the CPU 204 determines whether the target roller is a downstream roller. The CPU 204 moves the sequence to S1005 if the target roller is the downstream roller, and to S1007 if not. Performing S1001 and S1004 completes the determination of the upstream roller conveyance region (the first region), the upstream and downstream roller conveyance region (the second region), and the downstream roller conveyance region (the third region).

In S1005, the CPU 204 sets the downstream CISs 106-2 and 106-4 as the target CISs 106.

In S1006, the CPU 204 extracts the data of the downstream roller conveyance region (the third region) from all of the read data of the target CISs 106. As an extraction method, the extraction is performed from the number of read lines in the data obtained by reading the original 110 on which the dot pattern 401 is formed, in the same manner as in S1003.

In S1007, the CPU 204 sets all the CISs 106-1 to 106-5 as the target CISs 106.

In S1008, the CPU 204 extracts the data of the upstream and downstream roller conveyance region (the second region) from all of the read data of the target CISs 106. As an extraction method, the extraction is performed from the number of read lines in the data obtained by reading the original 110 on which the dot pattern 401 is formed, in the same manner as in S1003.

This completes the processing for obtaining the conveyance error caused by the original conveyance roller.

Sub Scanning Direction Magnification Obtainment Processing

A method for obtaining sub scanning direction magnification in the present embodiment will be described next with reference to FIG. 13. FIG. 13 is a flowchart illustrating details of the sub scanning direction magnification obtainment processing perform in step S902 of FIG. 11.

In S1101, the CPU 204 determines a main scanning section for which the sub scanning direction magnification is to be obtained. The main scanning section determined in this step is a main scanning region read by one of the plurality of chips in the CIS constituting one of the CISs 106.

In S1102, the CPU 204 searches, in the sub scanning direction, for the center coordinates of the circular dot pattern included in the main scanning section determined in S1101. First, a reference point and the main scanning ranging point are selected from among the center coordinates detected through the search. The “reference point” and the “main scanning ranging point” are center coordinates of the circular dot patterns for which the coordinates in the sub scanning direction are the same on the chart. Points in a positional relationship in which those points are located on respective sides of a pixel located at the center, of a predetermined main scanning section, of a sensor chip that reads the main scanning section, are selected as the reference point and the main scanning ranging point. Here, of the two selected pairs of center coordinates, the center coordinates on a main scanning direction reference side (a starting pixel side) are selected as the reference point, and the other center coordinates are selected as the main scanning ranging point.

After the reference point and the main scanning ranging point are selected, a sub scanning ranging point is selected. The “sub scanning ranging point” is center coordinates of the circular dot patterns for which the coordinates in the main scanning direction are the same on the chart, and the coordinate points of a position where the distance between the reference point and the main scanning ranging point and the distance between the reference point and the sub scanning ranging point are the same on the chart are selected.

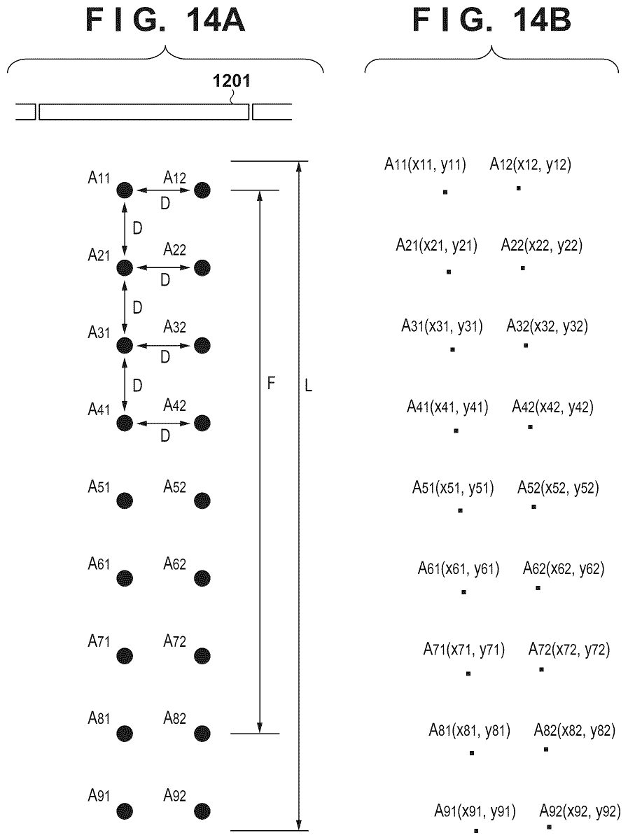

FIG. 14A illustrates a positional relationship between the chart in which the circular dot patterns are printed and a chip 1201 in the CIS 106 that performs the reading. FIG. 14B illustrates a positional relationship of the center coordinates of the circular dot pattern obtained on the basis of the data obtained as a result of reading the pattern illustrated in FIG. 14A.

Here, tilt of the CIS 106 and tilt of the chart on the original that has been set represent a state in which the center coordinates of the circular dot pattern are read offset in both the main scanning direction and the sub scanning direction. When A11 (x11, y11) is selected as the reference point for such data, A12 (x12, y12) is selected as the main scanning ranging point, and A21 (x21, y21) is selected as the sub scanning ranging point.

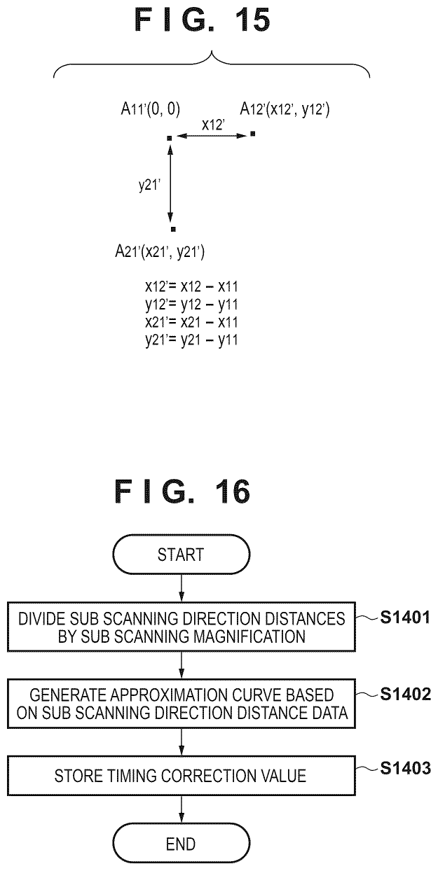

In S1103, the CPU 204 transforms the coordinates of each ranging point centered on the reference point A11 into relative coordinates. Assuming that the post-transform coordinates of A11 are A11′ (0, 0), A12 is transformed to A12′ (x12′, y12′), and A21 is transformed to A21′ (x21′, y21′). At this time, x12′=x12−x11, y12′=y12−y11, x21′=x21−x11, and y21′=y21−y11. The following will provide specific descriptions using these coordinates. FIG. 15 conceptually illustrates post-transform coordinate data.

In S1104, the CPU 204 performs correction on the coordinates transformed in S1103 (in this example, the post-transform coordinates A12′ and A21′), on the basis of tilt information of the CIS 106 obtained in the immediately-previous correction value obtainment. If the tilt angle of the corresponding chip is obtained as q through tilt detection for the CIS 106 performed immediately before, A12′ and A21′ are transformed to A12″ (x12″, y12″) and A21″ (x21″, y21″), respectively, using the coordinates A11′ as the reference point. Here, the correction processing can be omitted if the tilt of the CIS 106 or the chip 1201 is mechanically restricted and the tolerance does not affect the reading result. Through S1104, a distance between the reference point and the transformed main scanning ranging point A12″ (called a “main scanning direction distance”) x21″, and a distance between the reference point and the transformed sub scanning ranging point A21″ (called a “sub scanning direction distance”) y12″ can be obtained.

In S1105, the CPU 204 stores the main scanning direction distance x21″ and the sub scanning direction distance y12″ obtained in S1104 in the memory as distance data at the reference point A11.

Although the flow described thus far is processing for obtaining conveyance data information at a single reference point, the same processing is performed for the other center coordinates arranged in the sub scanning direction.

In S1106, the CPU 204 determines whether any center coordinates that can be selected as the reference point remain, on the basis of the stored center coordinate data. If no selectable center coordinates remain, the CPU 204 moves the sequence to S1107. However, if selectable center coordinates remain, the center coordinates of the circular dot pattern, shifted in the sub scanning direction by one place from the center coordinates selected as the reference point immediately before, are selected.

In this manner, the center coordinates from A11 to A(N−1)1 are selected as the reference point, and the distance to each ranging point, centered on the selected reference point, is obtained and recorded in the memory. When A(N−1)1 is selected as the reference point, AN1 becomes the sub scanning ranging point for A(N−1)1, and because there is no subsequent data, the processing ends. When the distance data is obtained for all the sections, in S1107, the CPU 204 reads that data out from the memory and finds the sub scanning direction magnification. The sub scanning magnification can be found through the following Formula (1).

a=(y21″+y31″+ . . . +yN1″)/(x12″+x2″+ . . . +x(N−1)2″) Formula (1)

The sub scanning magnification obtained through the foregoing calculation can be applied at the timing at which a trigger for starting the reading of a line occurs, enlargement/reduction correction performed in image processing, or the like.

### Suppression of Error Caused by Eccentricity of Original Conveyance Roller

Processing for suppressing error caused by eccentricity of the original conveyance roller will be described next with reference to FIG. 16. FIG. 16 is a flowchart illustrating details of the eccentricity error suppression processing performed in step S903 of FIG. 11.

The sub scanning direction distance (y21″, y31″, . . . , yN1″) in the post-transform coordinate data used when obtaining the sub scanning direction magnification described above can be used to obtain error caused by eccentricity. If the sub scanning direction magnification is not obtained in advance, the post-transform sub scanning direction distance is found through the processing of S1101 to S1106 in FIG. 13 prior to the flow of FIG. 16. The sub scanning direction distance obtained here also includes fluctuation resulting from the sub scanning direction magnification.

Accordingly, in S1401, the CPU 204 divides all the sub scanning direction distances by a sub scanning direction magnification a. If the sub scanning direction distances divided by the sub scanning direction magnification a are Δy2, Δy3, . . . , ΔyN, then ΔyN=yN1″/a.

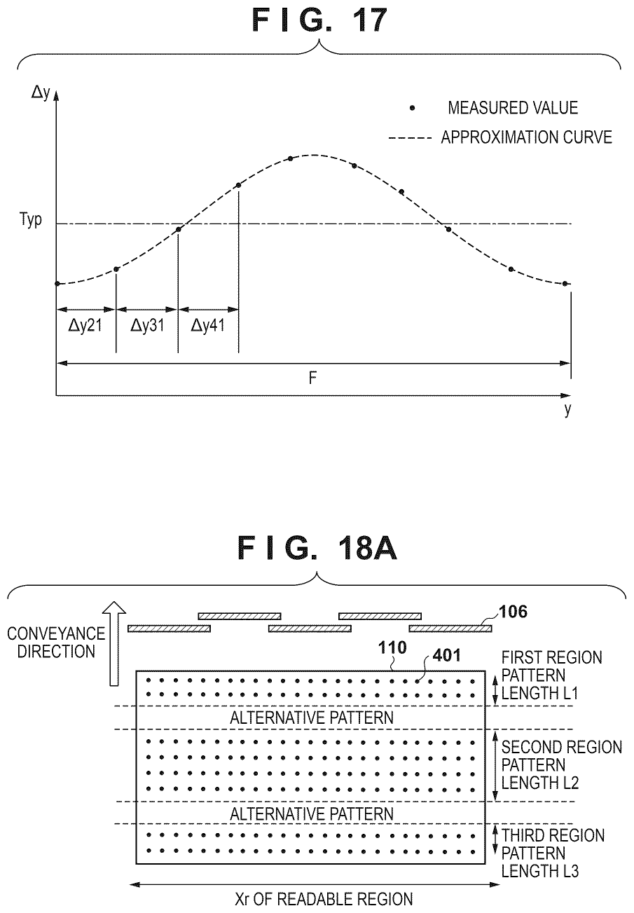

In S1402, the CPU 204 obtains an approximation curve in which ΔyN represents the conveyance amount per unit section, the vertical axis represents the conveyance amount Δy per unit section, and the horizontal axis represents a cumulative added value y of Δy. Performing cumulative addition on the sub scanning direction distances between all the dots in a region that is at least a conveyance amount F of one revolution of the original conveyance roller, and plotting the obtained values, results in an approximation curve such as that indicated by the broken line in FIG. 17, for example.

In S1403, the CPU 204 stores a timing correction value. Using a formula representing the approximation curve obtained in S1402 makes it possible to obtain a correction value for correcting the timing at which a trigger for the line sensor to start reading occurs, at any desired rotation angle of the original conveyance roller. A table for holding timing correction values for conveyance amounts of the unit sections is stored in the memory of the scanner 100, and the timing correction value obtained in S1403 is held in this table.

The timing correction data held in the timing correction table is read out during a normal reading operation, and is used to fine-tune the timing at which the trigger to start reading the line occurs. As a result of this fine-tuning, the timing at which the trigger to start reading the line occurs is earlier than the initial value in sections where the conveyance amount in the unit section is greater than the theoretical value, and the timing at which the trigger occurs is later than the initial value in sections where the conveyance amount in the unit section is lower than the theoretical value. Accordingly, even when there is a variation in the conveyance amount due to eccentricity of the original conveyance roller, the line reading period becomes constant, which makes it possible to improve the reading quality.

### Effects, etc. of Present Embodiment

In the present embodiment, in a sheet-feed type image reading apparatus including a plurality of CISs, conveyance error of an original conveyance roller can be obtained with high accuracy by switching a target CIS according to which conveyance mode is used among a first conveyance mode, in which an original is conveyed by upstream rollers only, a second conveyance mode, in which the original is conveyed by both upstream rollers and downstream rollers, and a third conveyance mode, in which the original is conveyed by the downstream rollers only.

Although described in the present embodiment, when using a configuration that switches the CIS 106, which performs the reading operation, for each conveyance mode, the CISs that are not used do not performing reading. This makes it possible to shorten the time required for data transfer, and shorten the reading time of the image reading apparatus.

Although the present embodiment has described a method for obtaining conveyance error using a dot pattern as the pattern in the original, the pattern is not limited to a dot pattern, and may be any pattern that enables the conveyance error to be obtained for each conveyance mode. For example, the conveyance error for each conveyance mode can be obtained using a pattern in which the horizontal lines are formed continuously at constant intervals.

### Second Embodiment

A second embodiment will describe processing for finding conveyance error of the original conveyance roller in each conveyance mode, even when a sufficient pattern length on the original cannot be secured. The following will mainly describe the differences from the first embodiment, and details that are the same as in the first embodiment will be omitted as appropriate.

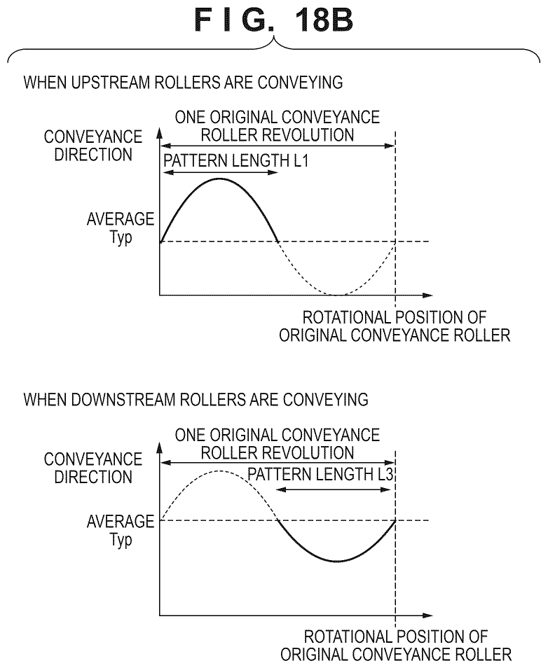

A method for obtaining the conveyance error caused by the error of the original conveyance roller according to the present embodiment will be described hereinafter with reference to FIGS. 18A to 21C.

FIGS. 18A and 18B are diagrams illustrating an issue with obtaining conveyance error when a sufficient pattern length on the original cannot be secured in each of the first to third conveyance modes.

FIG. 18A is a diagram illustrating a pattern arrangement on an original when a sufficient pattern length on the original cannot be secured.

As described in the first embodiment, it is desirable that the pattern length on the original be such that a circumferential length equivalent to one revolution of the original conveyance roller can be secured in each conveyance mode. However, if the pattern length used in each conveyance mode can be reduced, other patterns can be arranged in the resulting empty space.

The size of the original affects the cost, and thus if the empty space can be used effectively, the length of the original in the conveyance direction can be reduced, which in turn makes it possible to reduce the cost of the original. When the pattern length used in each conveyance mode is reduced, the upstream and downstream roller conveyance region (the second region) can be secured with a pattern length L2 that is at least the circumferential length Yr, as illustrated in FIG. 18A, for example. On the other hand, the upstream roller conveyance region (the first region) and the downstream roller conveyance region (the third region) have pattern lengths L1 and L3, which are shorter than the circumferential length Yr.

FIG. 18B is a diagram illustrating a change in conveyance error when a sufficient pattern length on the original cannot be secured in each conveyance mode. When the conveyance error is obtained in the state illustrated in FIG. 18A, the conveyance error can be obtained only within the range of the pattern length. As such, conveyance error equivalent to the circumferential length of the original conveyance roller cannot be obtained in the upstream roller conveyance region (the first region) and the downstream roller conveyance region (the third region). Accordingly, conveyance error in the first region and the third region cannot be obtained accurately.

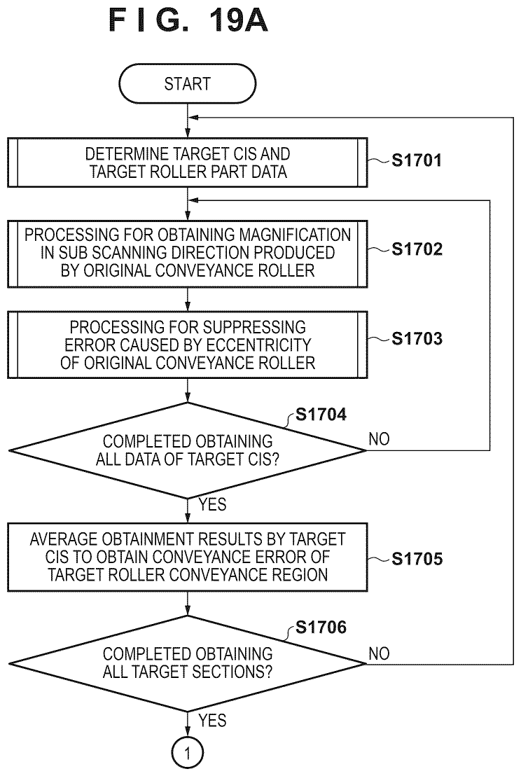

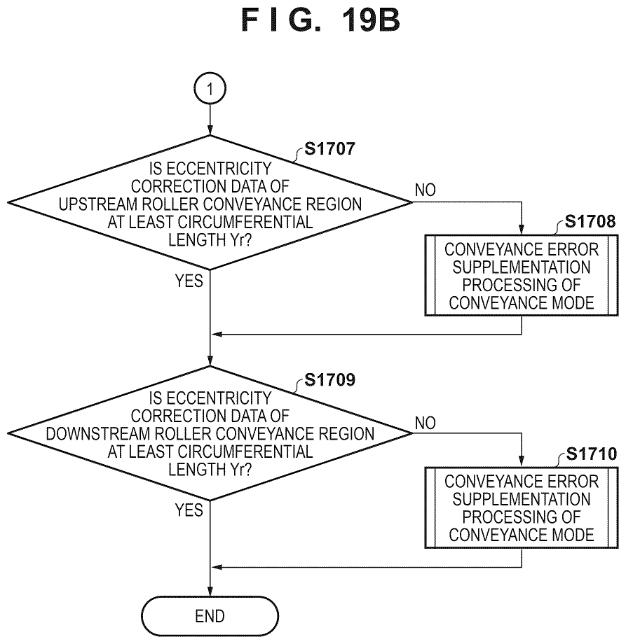

Next, flows for obtaining the conveyance error of the original conveyance rollers with high accuracy for each conveyance mode, even when a sufficient pattern length on the original cannot be secured, will be described with reference to the flowcharts in FIGS. 19 and 20, and FIGS. 21A to 21C.

FIGS. 19A and 19B are flowcharts illustrating processing for obtaining conveyance error produced by the original conveyance roller in a state where a sufficient pattern length on the original cannot be secured, and is a flowchart illustrating details of the conveyance error obtainment processing in S503 of FIG. 5.

S1701 to S1706 are similar to S901 to S906 of FIG. 11, and will therefore not be described.

In S1707, the CPU 204 determines whether the timing correction value (eccentricity correction data) of the upstream roller conveyance region (the first region) stored in S1403 of FIG. 16 is at least the circumferential length Yr. The CPU 204 moves the sequence to S1709 if the value is at least the circumferential length Yr, and to S1708 if not.

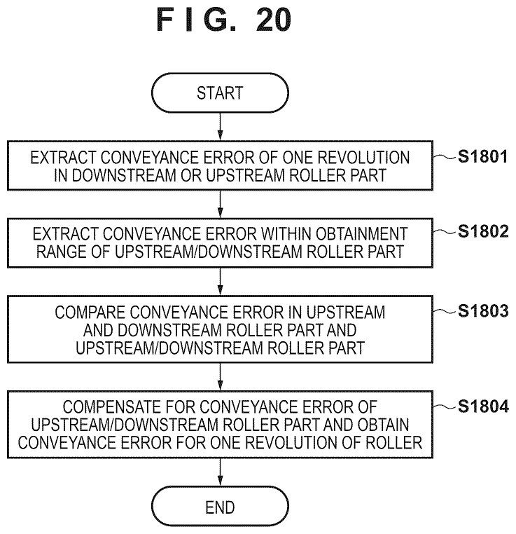

In S1708, the CPU 204 performs conveyance error supplementation processing in the first conveyance mode in which only the upstream roller is used. The supplementing is performed by comparing the conveyance error in the upstream roller conveyance region (the first region) and the upstream and downstream roller conveyance region (the second region). The flow of this processing will be described in detail with reference to FIG. 20.

In S1709, the CPU 204 determines whether the timing correction value (eccentricity correction data) of the downstream roller conveyance region (the third region) stored in S1403 of FIG. 16 is at least the circumferential length Yr. The CPU 204 ends the sequence if the value is at least the circumferential length Yr, and moves the sequence to S1710 if not.

In S1710, the CPU 204 performs conveyance error supplementation processing in the third conveyance mode in which only the downstream roller is used. Supplementing is performed by comparing the conveyance error in the downstream roller conveyance region (the third region) and the upstream and downstream roller conveyance region (the second region). The flow of this processing will be described in detail with reference to FIG. 20.

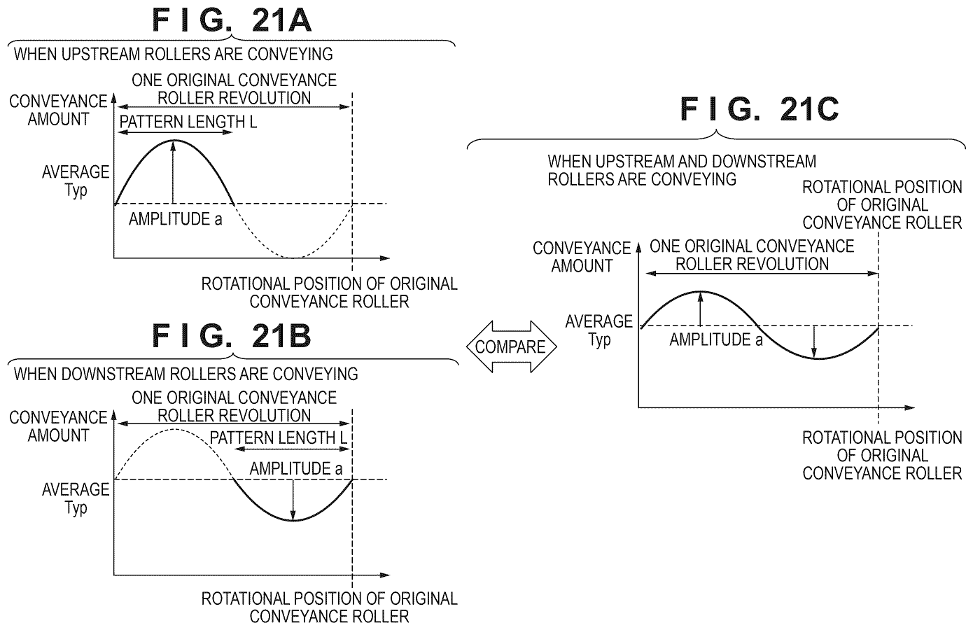

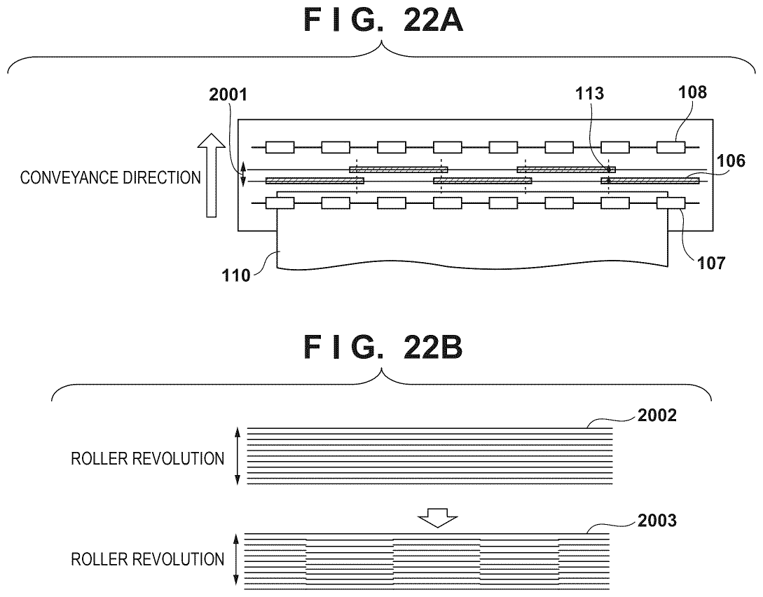

FIG. 20 is a diagram illustrating conveyance error supplementation processing in a state where a sufficient pattern length on the original cannot be secured, and is a flowchart illustrating the conveyance error supplementation processing in S1708 and S1710 of FIG. 19 in detail. FIGS. 21A to 21C are diagrams illustrating a method for comparing the conveyance error in the upstream and downstream roller conveyance region (the second region) and an upstream or downstream roller conveyance region (the first or third region).

In S1801, the CPU 204 extracts the conveyance error corresponding to one revolution of the roller in the upstream and downstream roller conveyance region (the second region). The conveyance error may be that obtained when the timing correction value stored in S1403 of FIG. 16 is used, or when the transform coordinate data in S1105 of FIG. 13 is used. When the timing correction value stored in S1403 of FIG. 16 is used, the conveyance error is converted into conveyance error including the sub scanning direction magnification by multiplying the conveyance error by the sub scanning direction magnification obtained in S1108 of FIG. 13. Although extraction of the data from the upstream and downstream roller conveyance region (the second region) is described as being equivalent to one revolution of the roller, the data may correspond to any number of revolutions as long as the number is at least one.

In S1802, the CPU 204 extracts the conveyance error within the range of obtainment for the upstream or downstream roller conveyance region (the first or third region). As in S1801, the conveyance error may be that obtained when the timing correction value stored in S1403 of FIG. 16 is used, or when the transform coordinate data in S1105 of FIG. 13 is used.

In S1803, the CPU 204 compares the conveyance error in the upstream and downstream roller conveyance region (the second region) and the upstream or downstream roller conveyance region (the first or third region) as indicated in FIGS. 21A to 21C. As the comparison method, if the pattern length L is about half the circumference of the original conveyance roller, an amplitude a of a variation curve for the conveyance error is used for the comparison, as illustrated in FIGS. 21A to 21C. Alternatively, if the pattern length L is about ¼ of the circumference of the original conveyance roller, a method such as comparing the rise and fall of the variation curve of the conveyance error may be used.

In S1804, the CPU 204 compensates for the conveyance error in the upstream or downstream roller conveyance region (the first or third region), and obtains the result as the conveyance error for one revolution of the roller. As the method for supplementing, a ratio of the amplitude a in the upstream or downstream roller conveyance region (the first or third region) is obtained based on the amplitude a in the upstream and downstream roller conveyance region (the second region), using the result of the comparison in S1803, for example. The obtained ratio is then multiplied by the conveyance error in the upstream and downstream roller conveyance region (the second region), and the variation curve of the conveyance error in the upstream or downstream roller conveyance region (the first or third region) is obtained. Alternatively, it is possible to estimate the amplitude a of the variation curve of the conveyance error from the rise and fall of the variation curve of the conveyance error, and perform the supplementing based on the ratio of the amplitude a in the upstream and downstream roller conveyance region (the second region) or the upstream or downstream roller conveyance region (the first or third region).

The correction value can be obtained by performing the same processing as in S1107 of FIG. 13 and S1401 to S1403 of FIG. 16, based on the data corresponding to one revolution of the roller used to compensate for the variation curve of the conveyance error in the upstream or downstream roller conveyance region (the first or third region), illustrated in FIGS. 21A to 21C. This makes it possible to obtain the conveyance error equivalent to one revolution of the roller in the upstream roller conveyance region (the first region) and the downstream roller conveyance region (the third region).

### Effects, etc. of Present Embodiment

According to the present embodiment, conveyance error of the original conveyance roller can be determined with high accuracy in the upstream roller conveyance region, the downstream roller conveyance region, and the upstream and downstream roller conveyance region, even when a sufficient pattern length on the original cannot be secured.

The present embodiment can also be applied in the configuration that switches the CIS described in the first embodiment, when the conveyance length of the upstream roller conveyance region and the downstream roller conveyance region is less than the circumferential length Yr of the original conveyance roller. For example, the present embodiment can be applied when the interval between the original conveyance rollers in the conveyance direction is shortened in order to further reduce the size of the image reading apparatus. By comparing the conveyance error of the upstream roller conveyance region and the downstream roller conveyance region with the conveyance error of the upstream and downstream roller conveyance region, the conveyance error of the original conveyance roller can be determined with high accuracy in each conveyance mode, in the same manner as when a sufficient pattern length on the original cannot be secured.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-208815, filed Dec. 11, 2023, which is hereby incorporated by reference herein in its entirety.

What is claimed is:

1. An image reading apparatus that conveys an original and reads the original, the image reading apparatus comprising:
a plurality of line image sensors disposed along a direction intersecting with a conveyance direction of the original, the line image sensors being disposed in a staggered manner shifted from each other alternately in the conveyance direction by a predetermined amount;
an upstream roller disposed upstream from the plurality of line image sensors in the conveyance direction of the original;
a downstream roller disposed downstream from the plurality of line image sensors in the conveyance direction of the original; and
at least one processor configured to function as:
a control unit that, in a case where detecting conveyance error by using the plurality of line image sensors to read an original on which is formed a detection pattern for detecting conveyance error of the upstream roller and the downstream roller, performs control such that in a first region of the original conveyed only by the upstream roller, the conveyance error is detected using read data from a line image sensor, among the line image sensors disposed in a staggered manner, that is disposed close to the upstream roller, and in a third region of the original conveyed only by the downstream roller, the conveyance error is detected using read data from a line image sensor, among the line image sensors disposed in a staggered manner, that is disposed close to the downstream roller.

2. The image reading apparatus according to claim 1,
wherein the control unit performs control such that, of read data from the detection pattern read by the plurality of line image sensors, the conveyance error is detected in the first region by selecting data read by the line image sensor disposed close to the upstream roller, and the conveyance error is detected in the third region by selecting data read by the line image sensor disposed close to the downstream roller.

3. The image reading apparatus according to claim 1,
wherein the control unit performs control such that in a case where reading the detection pattern in the first region, the reading is performed having selected a line image sensor, among the line image sensors disposed in a staggered manner, that is disposed close to the upstream roller, and in a case where reading the detection pattern in the third region, the reading is performed having selected a line image sensor, among the line image sensors disposed in a staggered manner, that is disposed close to the downstream roller.

4. The image reading apparatus according to claim 1,
wherein in a second region of the original conveyed by both the upstream roller and the downstream roller, the line image sensors read the detection pattern in a region corresponding to at least one revolution of a circumference of the upstream roller or the downstream roller.

5. The image reading apparatus according to claim 4,
wherein in the first region and the third region, the line image sensors read the detection pattern in a region shorter than the circumference of the upstream roller or the downstream roller.

6. The image reading apparatus according to claim 5,
wherein the control unit supplements data of the detection pattern in a region, of the first region and the third region, that does not reach a length of the circumference of the upstream roller or the downstream roller, with data read by the line image sensors in the second region.

7. The image reading apparatus according to claim 6,
wherein the control unit supplements the data of the detection pattern in the region, of the first region and the third region, that does not reach the length of the circumference of the upstream roller or the downstream roller, based on a ratio between (i) a change in the conveyance error based on the detection pattern read in the first region or the third region and (ii) a change in the conveyance error based on the detection pattern read in the second region.

8. The image reading apparatus according to claim 7,
wherein the control unit supplements data of the detection pattern in the region, of the first region and the third region, that does not reach the length of the circumference of the upstream roller or the downstream roller, by multiplying the ratio by the detection pattern read in the second region.

9. The image reading apparatus according to claim 1,
wherein the control unit detects conveyance error caused by eccentricity in the upstream roller and the downstream roller.

10. The image reading apparatus according to claim 1,
wherein the control unit detects conveyance error caused by error in diameters of the upstream roller and the downstream roller.

11. The image reading apparatus according to claim 1,
wherein the detection pattern is a pattern in which dots are arranged side-by-side in the conveyance direction and in a direction orthogonal to the conveyance direction.

12. A control method for an image reading apparatus that conveys an original and reads the original,
the image reading apparatus comprising:
a plurality of line image sensors disposed along a direction intersecting with a conveyance direction of the original, the line image sensors being disposed in a staggered manner shifted from each other alternately in the conveyance direction by a predetermined amount;
an upstream roller disposed upstream from the plurality of line image sensors in the conveyance direction of the original; and
a downstream roller disposed downstream from the plurality of line image sensors in the conveyance direction of the original, and
the control method comprising:
performing control, in a case where detecting conveyance error by using the plurality of line image sensors to read an original on which is formed a detection pattern for detecting conveyance error of the upstream roller and the downstream roller, such that in a first region of the original conveyed only by the upstream roller, the conveyance error is detected using read data from a line image sensor, among the line image sensors disposed in a staggered manner, that is disposed close to the upstream roller, and in a third region of the original conveyed only by the downstream roller, the conveyance error is detected using read data from a line image sensor, among the line image sensors disposed in a staggered manner, that is disposed close to the downstream roller.

13. A non-transitory computer-readable storage medium in which is stored a program for causing a computer to execute a control method of an image reading apparatus that conveys an original and reads the original,
the image reading apparatus comprising:
a plurality of line image sensors disposed along a direction intersecting with a conveyance direction of the original, the line image sensors being disposed in a staggered manner shifted from each other alternately in the conveyance direction by a predetermined amount;
an upstream roller disposed upstream from the plurality of line image sensors in the conveyance direction of the original; and
a downstream roller disposed downstream in the conveyance direction of the original, and
the control method comprising:
performing control, when detecting conveyance error by using the plurality of line image sensors to read an original on which is formed a detection pattern for detecting conveyance error of the upstream roller and the downstream roller, such that in a first region of the original conveyed only by the upstream roller, the conveyance error is detected using read data from a line image sensor, among the line image sensors disposed in a staggered manner, that is disposed close to the upstream roller, and in a third region of the original conveyed only by the downstream roller, the conveyance error is detected using read data from a line image sensor, among the line image sensors disposed in a staggered manner, that is disposed close to the downstream roller.
